(19) United States
(12) Patent Application Publication
(10) Pub. No.: US 2006/0147697 A1
(43) Pub. Date: Jul. 6, 2006

(54) Method for producing rear-injected plastic moulded parts

(76) Inventors: Juan Medina-Galarza, Picassent (ES); Marta Vilarasau-Durany, Balaguer (ES)

Correspondence Address: FAY KAPLUN & MARCIN, LLP, 15O BROADWAY, SUITE 702, NEW YORK, NY, 10038, US

(21) Appl. No.: 10/542,095

(22) PCT Filed: Dec. 22, 2003
(86) PCT No.: PCT/EP03/14916

§ 371 Date: Jan. 27, 2006

(30) Foreign Application Priority Data
Jan. 13, 2003 (DE) 103017127

(51) Int. Cl. B32B 3/26; B29C 45/14; B32B 9/00

(52) U.S. Cl. 428/314.4; 264/259; 264/266; 428/318.4

(57) ABSTRACT

Described is a method for producing rear-injected plastic moulded parts consisting of a decorative layer, a foam layer, and a substrate; each of which respectively consisting of polyolefins. According to the method, the decorative layer and the foam layer are inserted into an injection mould in the form of a composite, and are then rear-injected with the substrate material into the closed injection mould. In order to structure the outer surface of the decorative layer on the finished moulded part as desired, the inner surface of the injection mould, against which the decorative layer is applied, is structured in a complementary manner. A foam layer formed from closed cells is used, the layer being permanently compressed during the hardening of the substrate material in the closed injection mould according to the structuring of the surface of the injection mould. The structuring of the surface of the injection mould can be obtained by correspondingly shaping the surface itself or by inserts which are to be arranged between the surface of the injection mould and the decorative layer.

The invention relates to a process of the preamble of claim 1.

A process for producing rear-injected plastic mouldings with decoratively embossed surface coating is already known from German Patentschrift 19 729 780. The decorative material is thus placed in an injection-moulding die and the decorative material is then exposed to a gas under pressure when the die is closed, so that the decorative material is pressed into the cavities of the injection-moulding die. Rear-injection of the decorative material then takes place using a plastic, which forms the substrate of the moulding after curing. The decorative material may be covered by a porous nonwoven and/or a film on the rear side before placing in the injection-moulding die.

Plastic mouldings produced by rear-injection often also have a foam layer between the decorative layer and the substrate.

The known process has the disadvantage that it contains the additional step of pressure exposure by a gas between the placing of the decorative material and the injection of the substrate material and is therefore expensive.

It is therefore the object of the present invention to indicate a process for producing rear-injected plastic mouldings comprising a decorative layer, a foam layer and a substrate, which consist in each case of polyolefins, wherein the decorative layer and the foam layer in the form of a composite are placed in an injection-moulding die, and the latter are then rear-injected with the substrate material in the closed injection-moulding die, and wherein to achieve a required structuring of the outer surface of the decorative layer, the inner surface of the injection-moulding die, against which the decorative layer is applied, is structured in complementary manner, which is simpler than the known process and therefore requires a lower expense in terms of apparatus and also permits the production of the plastic mouldings with lower expense in terms of time.

This object is achieved according to the invention by a process having the features of claim 1. Advantageous developments of the process of the invention can be seen from the sub-claims.

Due to the fact that a foam layer of closed cells and having such properties is used, that it is compressed permanently during curing of the substrate material in the closed injection-moulding die corresponding to the structuring of the surface of the injection-moulding die, structuring of the surface of the decorative layer takes place during curing of the substrate material, so that the additional step of pressing the decorative layer against the injection-moulding die is dispensable.

After injecting the substrate material into the closed injection-moulding die, this material develops high compressive forces on the foam layer during curing mainly at the points at which the space for expansion is particularly restricted by the projections in the structure of the surface of the injection-moulding die. This leads to the fact that, since the surface of the substrate being formed and facing the foam layer is essentially flat, the foam layer is compressed corresponding to the structuring of the surface of the injection-moulding die. However, due to the high compressive stress, such damage to the foam layer takes place that the compressions are retained even after the end of the stress, that is, after opening the injection-moulding die and removal of the moulding from the latter. The finished moulding thus has a permanent surface structure which is complementary to the inner surface of the injection-moulding die. This permanent deformation of the foam layer is only obtained in the case of a foam of closed cells.

The compression of the foam layer may take place over a large surface area. It is thus possible to obtain structures on the surface of the moulding which may have both narrow depressions and narrow projections.

The structuring of the surface of the injection-moulding die may be obtained by corresponding shaping of the surface itself. This is advantageous when only the same mouldings are to be produced with the injection-moulding die. If on the other hand the injection-moulding die is to be used for the production of mouldings having different surface structure, it is advisable to obtain the structuring of the surface of the injection-moulding die by correspondingly shaped inserts between the surface of the injection-moulding die and the decorative layer. By exchanging the inserts, the surface structure of the mouldings may thus easily be changed.

The material, of which the injection-moulding die consists, that is, in particular aluminium or steel, is preferably selected as material for the inserts. However, a polyolefin, such as polyethylene or polypropylene, which contains a talcum powder admixture, may also be used.

The thickness of the non-compressed foam layer conventionally lies in the range from 2 to 6 mm, so that the maximum height differences of the surface structure obtained lie slightly below these values.

The recycling of the mouldings produced can be carried out in simple manner, if all three constituents—decorative layer, foam layer, substrate—consist of the same plastic, such as a polyolefin. Polypropylene has particularly advantageous properties.

Other suitable materials for the decorative layer are PET fabric and for the substrate, natural fibres or ABS.

The injection of the substrate material should take place if possible under low pressure, for example 60 bar. This prevents the foam layer also being compressed permanently at the injection points, and hence undesirable depressions in the structure of the moulding surface being produced at these points.

The invention is illustrated in more detail below using an exemplary embodiment shown in the figures.

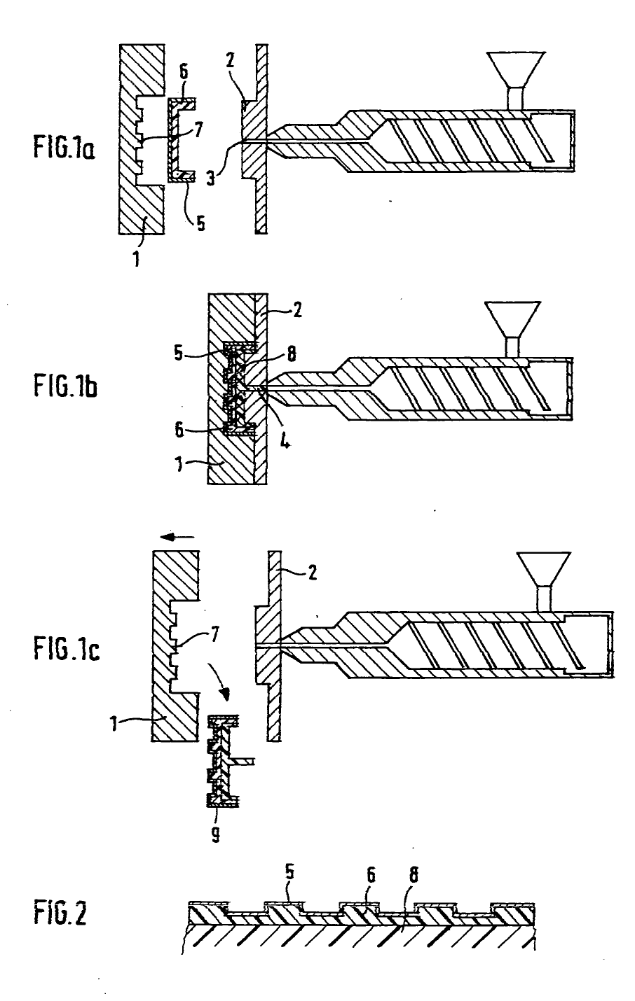

FIG. 1 shows in three stages the course of the process for producing a rear-injected plastic moulding, and

FIG. 2 shows a section through the decorative layer, the foam layer and a part of the substrate of a plastic moulding produced by the process of the invention.

FIG. 1 shows the known rear-injection process with an injection-moulding die comprising a female die 1 and a male die 2. The male die 2 contains injection bores 3 for the injection of the fluid substrate material 4 into the closed injection-moulding die (step B). Before the injection-moulding die is closed, the previously formed composite comprising the thin decorative layer 5 and the foam layer 6, which has a constant thickness in the range from 2 to 4 mm, is placed in the female die 1 with the decorative layer 5 resting against the die surface (step A). The surface facing the decorative layer 5 is structured, as indicated by projections 7. This structuring is obtained by corresponding shaping of the surface of the female die 1 itself or by the inserts forming projections 7, and which may be exchanged as required.

After inserting the decorative layer 5 and the plastic layer 6, the injection-moulding die is closed and the substrate material 4 is injected at a temperature of, for example 190 degrees Celsius (step B). The latter then cures and thus exerts a pressure on the surrounding surfaces. This pressure is highest where the free space for the shaping of the substrate 8 is restricted most severely by the projections 7. The process parameters are set so that in spite of the projections 7, the surface of the substrate 8 being formed and facing the foam layer 6 is essentially flat; with the result that the foam layer 6 is compressed correspondingly in the region of the projections 7. Furthermore, the process parameters are selected so that the pressure of the substrate material 4 on the foam layer 6 consisting of closed cells in the region of the compressions is so great that these compressions are retained even after relieving the foam layer 6 and hence permanent structuring of the surface of the cured moulding 9 formed by the decorative layer 5 and which is removed from the opened injection-moulding die (step C) is achieved.

FIG. 2 shows a section though a part of the moulding 9, from which the structuring of the surface formed by the composite comprising decorative layer 5 and foam layer 6 can be seen. The structuring consisting of bars and depressions alternating with one another is obtained in the region of the depressions by corresponding permanent compression of the foam layer 6 originally having a constant thickness.

1-10. (canceled)

11. A process for producing a moulding, comprising:
situating a composite formed of a decorative layer and a foam layer of closed cells in an injection-moulding die, a shape of a portion of a molding surface against which the decorative layer is situated complementing a desired shape of the decorative layer;
rear-injecting the foam layer with a substrate material in the closed injection-moulding die; and
permanently compressing the foam layer during curing of the substrate material in the closed injection-moulding die.

12. The process according to claim 11, further comprising:
forming a shape of a portion of the injection-moulding die as the moulding surface.

13. The process according to claim 11, further comprising:
forming the moulding surface by placing inserts of a desired shape between an inner surface of the injection-moulding die and the decorative layer.

14. The process according to claim 13, wherein the inserts are formed of a material the same as that of which the injection-moulding die is formed.

15. The process according to claim 13, wherein the inserts consist of a polyolefin treated with a talcum powder.

16. The process according to claim 11, wherein a thickness of the non-compressed foam layer is in a range between 2 and 6 mm.

17. The process according to claim 11, wherein height differences of the structure of the decorative layer are smaller than a thickness of the non-compressed foam layer.

18. The process according to claim 11, wherein each of the decorative layer, the foam layer and the substrate is composed of a polyolefin.

19. The process according to claim 11, wherein the injection of the substrate material into the injection-moulding die is performed under a low pressure.

20. The process according to claim 19, wherein the injection of the substrate material is performed at a pressure of about 60 bar.

21. A moulding produced according to a process of claim 11.

22. A moulding, comprising:
a decorative layer;
a foam layer of closed cells; and
a substrate,
wherein a composite formed of a decorative layer and a foam layer of closed cells is situated in an injection-moulding die,
wherein a shape of a portion of a molding surface against which the decorative layer is situated complements a desired shape of the decorative layer, and
wherein the foam layer with a substrate material is rear-injected in the closed injection-moulding die, the foam layer is permanently compressed during curing of the substrate material in the closed injection-moulding die.

23. The moulding according to claim 22, wherein the moulding surface is formed by placing inserts of a desired shape between an inner surface of the injection-moulding die and the decorative layer.

24. The moulding according to claim 23, wherein the inserts are formed of a material the same as that of which the injection-moulding die is formed.

25. The moulding according to claim 23, wherein the inserts consist of a polyolefin treated with a talcum powder.

26. The moulding according to claim 22, wherein a thickness of the non-compressed foam layer is in a range between 2 and 6 mm.

27. The moulding according to claim 22, wherein height differences of the structure of the decorative layer are smaller than a thickness of the non-compressed foam layer.

28. The moulding according to claim 22, wherein each of the decorative layer, the foam layer and the substrate is composed of a polyolefin.

29. The moulding according to claim 22, wherein the injection of the substrate material into the injection-moulding die is performed under a low pressure.

30. The moulding according to claim 29, wherein the injection of the substrate material is performed at a pressure of about 60 bar.
